(19) United States
(12) Patent Application Publication
(10) Pub. No.: US 2004/0091228 A1
(43) Pub. Date: May 13, 2004

(54) High performance fiber optic attenuator and attenuating element

(75) Inventors: Frank Calabrese, Cumming, GA (US); Kaushik Chakrabarty, Norcross, GA (US); Arturo Hale, New York, NY (US)

Correspondence Address: Law Office of Leo Zucker, Suite 480, 50 Main Street, White Plains, NY, 10606-1964, US

(73) Assignee: Fitel USA Corp.

(21) Appl. No.: 10/291,323

(22) Filed: Nov. 9, 2002

(51) Int. Cl. G02B 6/00; G02B 6/38

(52) U.S. Cl. 385/140; 385/73

(57) ABSTRACT

First and second parts of a fiber optic attenuator body receive first and second end portions of corresponding optical fibers. A polymeric thermoplastic attenuating element is mounted in a third part of the body so that a first contact face of the element optically couples to an end face on the first fiber end portion, and a second contact face of the element couples to an end face on the second fiber end portion, once the first and second attenuator body parts are connected to the third body part. In one embodiment, the attenuating element is formed of a copolymer of methylmethacrylate (MMA) and trifluoroethylmethacrylate (TFEMA). In another embodiment, the attenuating element is formed from polymethyl-2-fluoroacrylate (PFMA). Both elements exhibit a reflectance of −50 dB or less, a Tg of more than 100 degrees C., and a transmission of more than 85% at wavelengths from 850 nm to 1620 nm.

### BACKGROUND OF THE INVENTION

1. Field of the Invention

This invention relates to light signal attenuators for use in fiber optic communication systems or networks.

2. Discussion of the Known Art

Light sources for use in fiber optic communication systems are typically constructed to produce light at certain wavelengths and fixed power (intensity) levels. In some instances, however, the intensity of the produced light may be too high for sensitive receivers which are operatively connected relatively close to the light sources in a given system. Because optical receivers usually can tolerate only limited input power levels, fiber optic attenuators must be inserted in those transmission paths in which the light sources are at relatively short distances from the receivers in order to ensure safe power levels at the receiver inputs. Ideally, a given attenuator should reduce the intensity of the light by a fixed amount over all operating wavelengths. Commercially available component attenuators typically have fixed values of attenuation in the order of, e.g., 3 dB, 9 dB, 15 dB or more. Precision variable attenuators are also commercially available.

Fixed attenuators for use with single mode fibers (SMF) are known, wherein an air gap of a determined size is formed between end faces of first and second fibers. In the absence of a light guide within the air gap, an optical signal of a certain original signal intensity leaves the end face of, e.g., the first fiber, and spreads within the gap so that less than the original signal intensity becomes incident on the end face of the second fiber. Because high reflections are produced at the interfaces between the end faces of the fibers and the air gap, attenuators in which a clear solid polymeric disk is interposed between the fiber end faces, instead of an open air gap, have been developed. See W. W. King, et al, Plastic-Gap Attenuation, Proceedings NFOEC (2001), at pages 742-51.

When placed in fiber optic communication systems or networks, component attenuators should present as low a value of reflectance as possible. Otherwise, light reflected from an input or transmitter side of the attenuator could be returned to a light transmitter (typically a laser light source) and introduce undesirable noise. Thus, the attenuating element should have a refractive index (R.I.) as close as possible to that of the core of the transmitting fiber at the operating transmission wavelengths. Typically, fiber cores have a R.I. of about 1.44 to 1.46 (with a typical value of about 1.45). The refractive index of the fiber core depends on its material properties and its geometrical profile.

Reflectance is related to the difference between the refractive index of the attenuating element and that of the fiber core. For a step index fiber, reflectance is given by:

Reflectance (in dB)=−10 log₁₀[f(n_{co}−nₚ)²/(n_{cl}+nₚ)²+(1−f)(n_{cl}−nₚ)²/(n_{cl}+nₚ)²]

Where:

f is the relative fraction of guided power in the fiber core,

n_{co} is the refractive index of the fiber optic core,

n_{cl} is the refractive index of the fiber optic cladding,

nₚ is the refractive index of the attenuating element.

In general, at an interface between materials of different refractive indices, reflectance is given by:

Reflectance (in dB)=−10 log₁₀ [(n_{cl}−nₚ)²/(n_{cl}+nₚ)²]

For high speed networks, it is desirable to have reflectance values lower than −40 dB, and preferably lower than −50 dB. This means that the refractive index of material forming the attenuating element should be in the range of 1.420 to 1.480, for transmission wavelengths of 850 nanometers (nm) to 1620 nm (when the element is used with optic fibers whose core refractive index is in the range of 1.44 to 1.46, with a typical value of 1.45).

The bodies of fixed component attenuators are typically formed of two mating connector parts, and each connector part has an axially aligned ferrule in which an associated fiber is axially restrained with its end face exposed at a distal end of the ferrule. An attenuating element within the body of the attenuator comes into direct contact with the end faces of the fibers, and is subjected to a compressive load by the end faces when the connector parts are joined to one another. It is therefore desirable that the attenuating element be resistant to deformation over a range of temperatures that are expected to be encountered during operation. Component attenuators are typically required to perform reliably at temperatures of up to 75 degrees C. under test conditions. At high transmission power levels (e.g., around 20 dBm), surface temperatures of the attenuating element may rise as high as 90 degrees C.

If the attenuating element is made of a thermoplastics material, it must also resist deformation under load over long periods of time, i.e., “creep”. Polymeric thermoplastic materials usually resist creep, as well as short term deformation, if the operating temperature is maintained at least 10 to 15 degrees C. below a so-called glass transition temperature (Tg) of the material. Tg is defined as the temperature at which an amorphous or semi-crystalline polymer softens due to the onset of long-range coordinated molecular motion. It is therefore desirable to use materials having a Tg>100 degrees C. and, preferably, a Tg>120 degrees C., for attenuating element applications.

Polymeric thermoplastic materials that are now used as attenuating elements in fixed component attenuators, have one or both of the following limitations:

1. They exhibit a reflectance that is higher than −40 dB (i.e., the difference in R.I. between the core of the transmitting fiber and the thermoplastic element is greater than 0.03); and

2. The material cannot resist deformation under load at normal service temperatures and/or at elevated temperatures which are encountered at relatively high power levels of transmitted light (i.e., the Tg of the material is too low).

U.S. Pat. No. 5,082,345 (Jan. 21, 1992) describes an attenuating element made from polymethylmethacrylate (PMMA). The material has a refractive index of 1.4900 (n²⁰_{D}) which produces, at best, a reflection of −40 dB. The term (n²⁰_{D}) connotes that the refractive index was measured at 20 degrees C. using a Na-D light source which has a wavelength of 589 nm.

U.S. Pat. No. 5,619,610 (Apr. 8, 1997) discloses an optical terminating element made of a copolymer of propylene and 4-methyl-1-pentene. The refractive index (n²⁰_{D}) of the copolymer is 1.463, and it obtains a reflection of −50 dB. But the Tg of the material is only 25 degrees C. Therefore, the copolymer of the '610 patent is not suitable for use as an attenuating element at temperatures likely to be encountered in service. See also U.S. Pat. No. 5,818,992 (Oct. 6, 1998) which discloses an optical terminating element made of PMMA and having a Tg>80 degrees C.

An optical attenuating element that exhibits a reflection of less than 40 dB, a Tg greater than 100 degrees C., and which transmits at least 85% of incident light at a transmission wavelength range of, e.g., 850 to 1620 nm, would be highly desirable for use in modern optical communication systems and networks.

### SUMMARY OF THE INVENTION

According to the invention, a fiber optic attenuator has an attenuator body a first part of which is arranged to receive a first end portion of a first optical fiber, and a second part of which is arranged to receive a second end portion of a second optical fiber. An attenuating element including a generally disc shaped body portion has a first planar contact face on a first side of the body portion and a second planar contact face on a second, opposite side of the body portion. The attenuating element is mounted in a third part of the attenuator body so that the first contact face of the element is optically coupled to a first end face on the first end portion of the first fiber when the first part of the attenuator body is connected to the third part, and the second contact face of the element is coupled to a second end face on the second end portion of the second fiber when the second part of the attenuator body is connected to the third part. The body portion of the attenuating element is a polymeric thermoplastic material made a copolymer of methylmethacrylate (MMA) and trifluoroethyl-methacrylate (TFEMA) having a molecular weight in the range of about 20,000 to 500,000. The relative proportion of MMA to TFEMA is in the range of about 50/50 to 90/10 by weight of MMA/TFEMA.

According to another aspect of the invention, a fiber optic attenuator has an attenuator body a first part of which is arranged to receive a first end portion of a first optical fiber, and a second part of which is arranged to receive a second end portion of a second optical fiber. An attenuating element including a generally disc shaped body portion has a first planar contact face on a first side of the body portion and a second planar contact face on a second, opposite side of the body portion. The attenuating element is mounted in a third part of the attenuator body so that the first contact face of the element is optically coupled to a first end face on the first end portion of the first fiber when the first part of the attenuator body is connected to the third part, and the second contact face of the element is coupled to a second end face on the second end portion of the second fiber when the second part of the attenuator body is connected to the third part. The body portion of the attenuating element is made of a polymeric thermoplastic material comprising polymethyl-2-fluoroacrylate (PMFA).

For a better understanding of the invention, reference is made to the following description taken in conjunction with the accompanying drawing and the appended claims.

### BRIEF DESCRIPTION OF THE DRAWING

In the drawing:

FIG. 1 is a perspective, assembly view with parts broken away, showing a fiber optic attenuator having an attenuating element according to the invention;

FIG. 2 is a cross sectional view taken in the direction of the axis of the attenuator of FIG. 1, and showing the attenuator in an assembled state;

FIG. 3 is a perspective view of an attenuating element formed of a material according to the invention;

FIG. 4 is a table comparing performance characteristics for an optical attenuator element made from MMA/TFEMA copolymer according to the invention, with those of a current attenuating element; and

FIG. 5 is a table comparing performance characteristics for an optical attenuator element made from PMFA polymer according to the invention, with those of a current attenuating element.

### DETAILED DESCRIPTION OF THE INVENTION

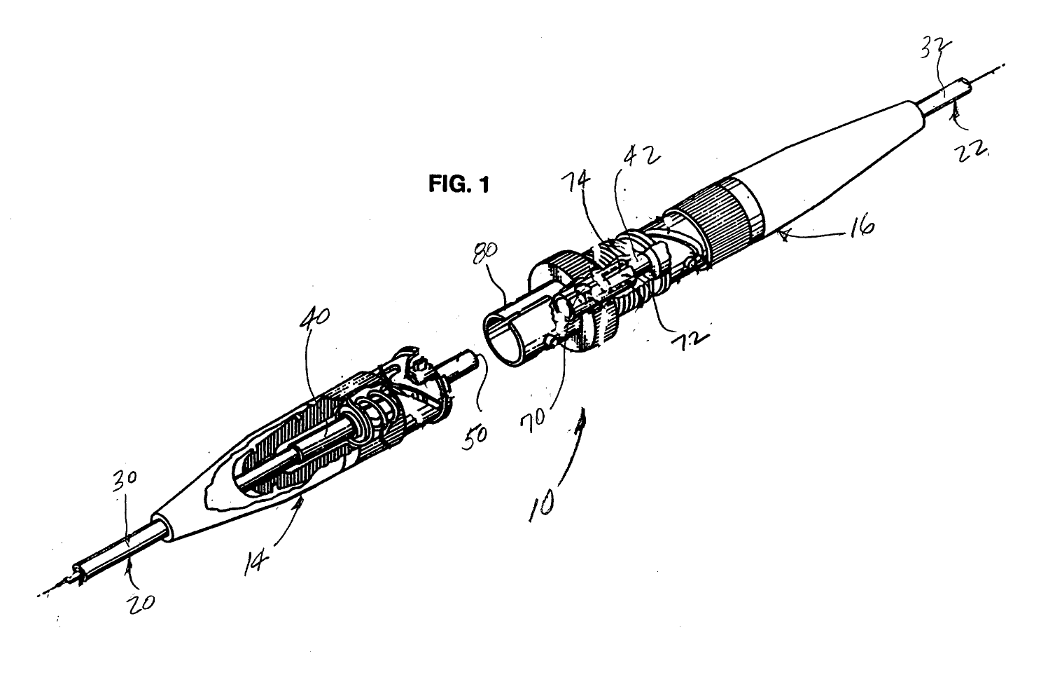

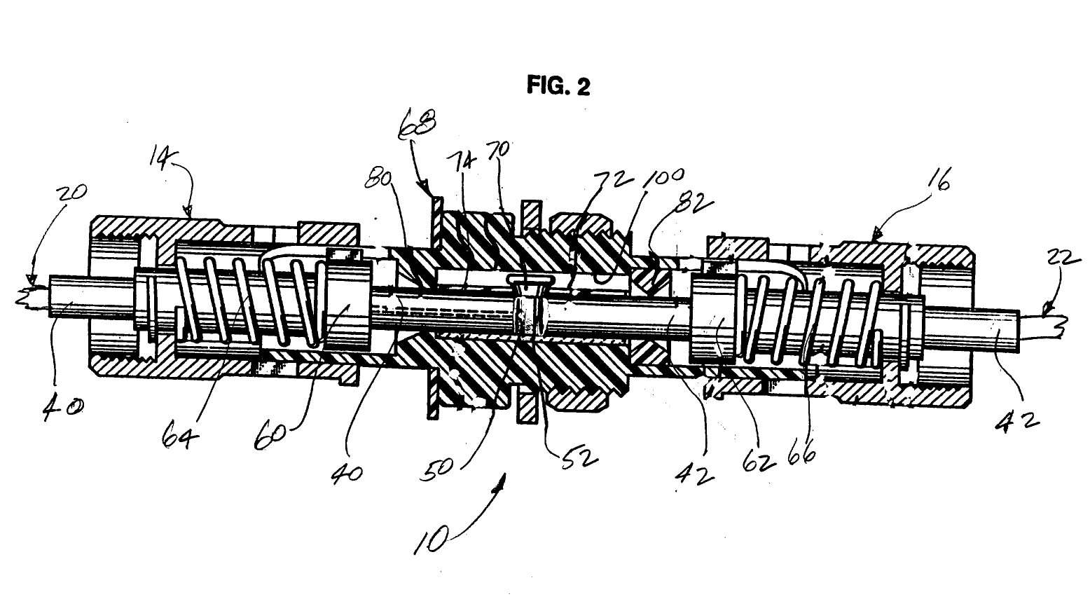

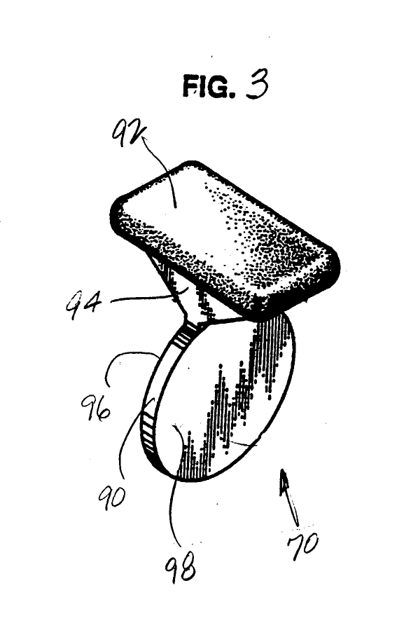

FIGS. 1 and 2 show a component fiber optic attenuator 10, including an attenuating element 70 (see FIG. 3) that is formed of a material according to the invention. The body of the attenuator 10 may be constructed the same or equivalent to the structure disclosed in, for example, U.S. Pat. No. 5,082,345 (Jan. 21, 1992). All relevant portions of the mentioned '345 patent are incorporated by reference.

In the illustrated embodiment, the attenuator 10 includes first and second elongated fiber optic plug assemblies 14, 16. The assemblies 14, 16 are constructed to receive exposed end portions of first and second optical fibers 20, 22, and to secure the fiber end portions in axial alignment within the plug assemblies. Typically, the fibers 20, 22 have outer jackets 30, 32 made of PVC and/or other material for protectively surrounding the fiber cladding and core. Accordingly, the outer jackets 30, 32 are first removed from the end portions of the fibers 20, 22, and the exposed fiber end portions are then inserted through axial passageways of corresponding ferrules 40, 42 which are mounted coaxially within the two plug assemblies 14, 16. When the two plug assemblies 14, 16 are assembled as explained below, confronting distal ends of the ferrules 40, 42 are brought into axial alignment with one another. Planar end faces 50, 52 are cleaved and polished on the end portions of the fibers 20, 22, at the distal ends of the ferrules 40, 42.

The ferrules 40, 42 are supported coaxially for sliding movement in the plug assemblies 14, 16 within corresponding cylindrical jackets 60, 62. The jackets 60, 62 are biased by associated coil springs 64, 66 mounted on the circumference of the jackets, so that the distal ends of the ferrules 40, 42 together with the end faces 50, 52 of the two fibers 20, 22 are biased to project axially outward from the distal ends of the two plug assemblies 14, 16.

In the disclosed embodiment, the body of the fiber optic attenuator 10 also includes a generally cylindrical coupling assembly 68, within which the attenuating element 70 formed of a material according to the invention is operatively disposed. The coupling assembly 68 has a sleeve 72 that extends coaxially within the assembly, and the sleeve 72 has a longitudinal slot 74 through the circumference of the sleeve over its entire length. The coupling assembly 68 also has two axially aligned and oppositely facing cylindrical connecting members 80, 82. The connecting members 80, 82 are constructed and arranged operatively to engage and connect with corresponding connecting members 84, 86 on the plug assemblies 14, 16.

The optical attenuating element 70 has a form which may be the same or similar to that shown in FIG. 3. A main body portion 90 of the element 70 is generally disc shaped, with a thickness that corresponds to a level of attenuation desired to be introduced between the end faces 50, 52 of the optical fibers 20, 22 in FIGS. 1 and 2. The main body portion 90 has two oppositely facing planar end faces 96, 98 which are formed and dimensioned to contact and to couple optically with the end faces 50, 52 of the first and the second optical fibers 20, 22 in FIGS. 1 and 2.

The element 70 also has a head portion 92 that is joined to its body portion 90 through a neck 94 that extends radially from the circumference of the body portion 90. The thickness of the neck is such as to enable it to be received and to slide freely within the slot 74 of the coupling assembly sleeve 72, so that the main body portion 90 of the element 70 may assume an operating position along the axis of the sleeve 72 as the element end faces 96, 98 are brought into contact with the end faces 50, 52 of the fibers 20, 22 when the plug assemblies 14, 16 are connected to the coupling assembly 68. The head portion 92 of the attenuating element 70 has, in the disclosed embodiment, a generally rectangular configuration that enables it to be captured for movement within a channel 100 (see FIG. 2) that is formed in the body of the coupling assembly 68, adjacent to the longitudinal slot 74 in the sleeve 72.

Once the main body portion 90 of the attenuating element 70 is placed inside the coupling assembly sleeve 72, the plug assemblies 14, 16 are mated to the corresponding connecting members 80, 82 of the coupling assembly 68. The end faces 50, 52 on the optical fibers 20, 22, which are disposed at the distal ends of the ferrules 40, 42, are then urged via the bias springs 64, 66 against the end faces 96, 98 of the attenuating element 70.

It has been discovered that if the main body portion 90 of the attenuating element 70 is formed of certain materials such as described below, fixed values of attenuation may be obtained for the attenuator 10 ranging from, e.g., about 0.5 to 20 or more dB with a reflection of less than −40 dB dB, a Tg of greater than 100 degrees C., and transmission of at least 85% of incident light through the element 70 at transmission wavelengths of from 850 to 1620 nanometers.

### EXAMPLE 1

### Attenuating Element Material A

A thermoplastic material for the element 70 was synthesized as a copolymer of methyl methacrylate (MMA) and trifluoroethylmethacrylate (TFEMA), with a molecular weight in the range of about 20,000 to 500,000. The relative composition of MMA and TFEMA was in the range of about 50/50 to about 90/10 (MMA/TFEMA wt. %/wt. %). The composition is the relative proportion of the two comonomers—MMA and TFEMA—that were added together in the reaction to yield the copolymer. The copolymer material may be synthesized using a free radical polymerization method in bulk, solution, or emulsion. See, for example, C. U. Pittman, et al, Journal of Polymer Science, Polymer Chemistry Edition, vol. 18 (12) (1980) at pages 3413-25 which are incorporated herein by reference.

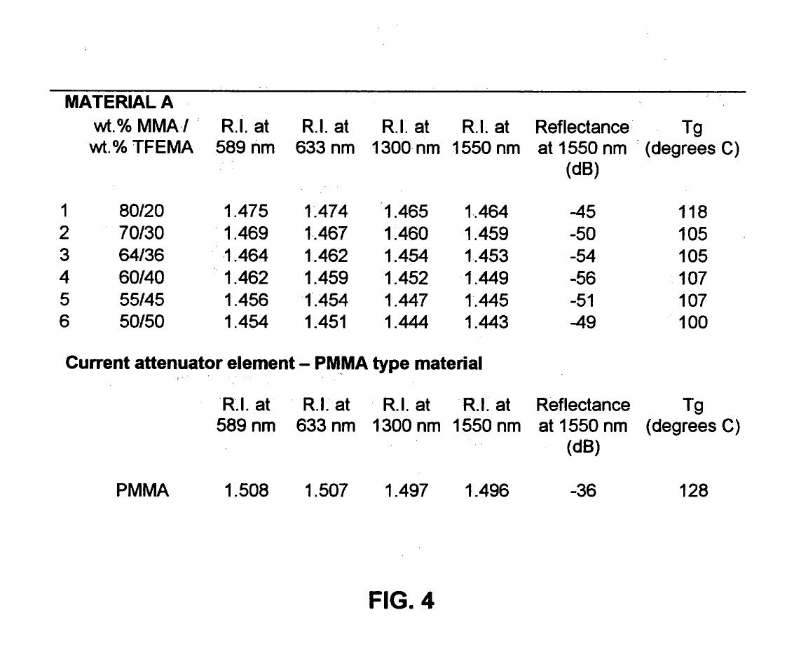

The table of FIG. 4 shows the refractive index, measured reflectance and the Tg of material A, as compared to a Polymethylmethacrylate (PMMA) type material that is currently used for attenuator elements.

Further, insertion loss measurements were made on a sample element formed of the material A before and after exposing the element for 60 hours to a laser light source at a wavelength of 1550 nm and a high power of 23 dBm. The measured insertion loss prior to exposure to the high power was 20 dB, and the of change in insertion loss after exposure to the high power was less than 0.5 dB. The element was also viewed under magnification for signs of visible damage, with none being found.

Elements formed of the material A having the compositions (wt. % MMA/wt. % TFEMA) shown in the table of FIG. 4, all exhibit the following desirable characteristics:

a. A refractive index value in the range 1.42 to 1.48 in the wavelength range of 589 nm to 1550 nm. The refractive index can be controlled by the relative proportion of MMA and TFEMA in the copolymer. This property allows the element to have a reflectance of −40 dB or lower in the wavelength of 850 nm to 1620 nm.

b. A measured reflectance that is lower than −40 dB at 1550 nm. A specific case (wt. % MMA/wt. % TFEMA=60/40) achieves a reflectance that is less than −55 dB at the transmission wavelength of 1550 nm.

c. A Tg that is greater than 100 degrees C., and resistance to deformation under load at operating temperatures up to 85 degrees C.

d. A transmission greater than 85% in the wavelength range of 850 nm to 1620 nm.

### EXAMPLE 2

### Attenuating Element Material B

The element 70 was formed of polymethyl-2-fluoroacrylate (PMFA), a polymer which may be synthesized from methyl-2-fluoroacrylate monomer by a free radical polymerization method in bulk, solution or emulsion. Such methods are described in, for example, C. U. Pittman, et al, Macromolecules, vol. 13 (1980), at pages 1031-36 which are incorporated by reference.

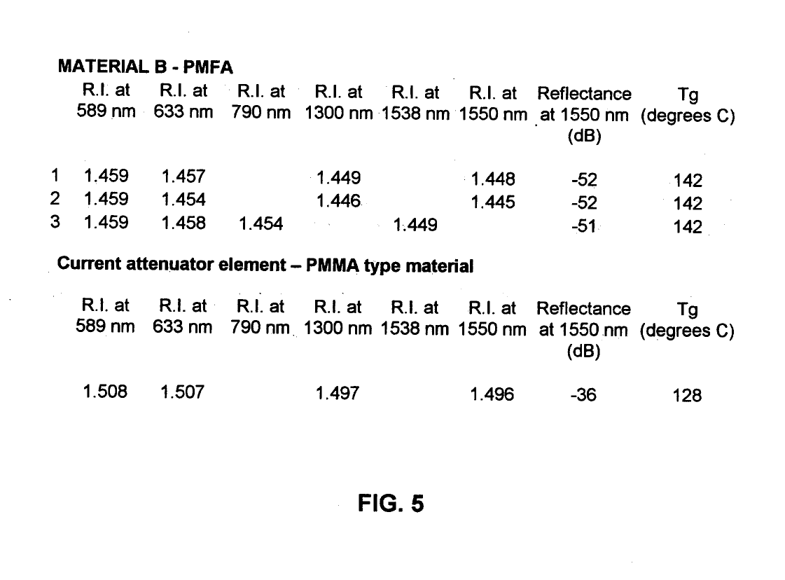

The table of FIG. 5 shows the refractive index, measured reflectance and the Tg of material B, as compared to a Polymethylmethacrylate (PMMA) type material that is currently used for attenuator elements

Further, insertion and return loss measurements were made on two sample elements formed of the material B after exposure to a laser light source at a wavelength of 1550 nm and at a high power of 30.6 dBm (i.e., approx. 1 watt).

Sample 1 was formed so that the main body portion 90 of the element was sufficiently thin to provide a measured insertion loss of 3.3 dB. The measured return loss (reflectance) for sample 1 was −45.62 dB. The sample was also viewed under magnification for signs of visible damage, with none being found.

Sample 2 was thicker than sample 1, and measured 2.5 mm both before and after the high power tests with no noticeable difference. The sample was also viewed under magnification for signs of visible damage, with none being found. The measured insertion loss for sample 2 was 23.52 dB, and the measured return loss was −50.10 dB.

Elements formed of the material B all exhibit the following desirable characteristics:

a. A refractive index in the range of 1.44 to 1.46 at wavelengths from 589 nm to 1550 nm. This property allows the element to have a reflectance of −50 dB or lower in the wavelength range of 850 nm to 1620 nm.

b. A measured reflectance better than −50 dB at the transmission wavelength of 1550 nm.

c. A Tg that is greater than 140 degrees C., and resistance to deformation under load at operating temperatures of up to 125 degrees C.

d. A transmission that is greater than 85% at wavelengths of from 850 nm to 1620 nm.

Both of the element materials A and B are polymeric thermoplastic materials that can be fabricated into the form of the attenuating element 70 using known injection or compression molding techniques. Manufacturing costs for the element 70 are therefore lower than would be incurred if the element 70 was formed from other materials such as glass or ceramics.

The refractive index of both materials A and B closely matches that of typical optical fiber cores, i.e., the R.I. of either material A or B is within the range of 1.42 to 1.48 at wavelengths from 589 nm to 1620 nm, thus realizing an element reflectance of less than −40 dB.

The Tg of both materials A and B is greater than 100 degrees C. Therefore, the element 70 when formed of either material will be resistant to creep at operating temperatures. Both materials resist deformation under normal service load at ambient temperatures. Material A resists deformation under normal service loads up to 85 degrees C., and material B resists deformation under normal service loads up to 125 degrees C. Further, both of the materials A and B transmit at least 85% of incident light in the wavelength range of 850 to 1620 nm.

While the foregoing represents preferred embodiments of the invention, it will be understood by those skilled in the art that various modifications and changes may be made without departing from the spirit and scope of the invention, and that the invention includes all such modifications and changes as come within the scope of the following appended claims.

We claim:

1. A fiber optic attenuator, comprising:
an attenuator body a first part of which is constructed and arranged to receive a first end portion of a first optical fiber, and a second part of which is constructed and arranged to receive a second end portion of a second optical fiber; and
an attenuating element including a generally disc shaped body portion having a first planar contact face on a first side of the body portion and a second planar contact face on a second, opposite side of said body portion; wherein
the attenuating element is mounted in a third part of the attenuator body so that the first contact face of the element is optically coupled to a first end face on the first end portion of the first optical fiber when the first part of the attenuator body is connected to said third part, and the second contact face of the element is optically coupled to a second end face on the second end portion of the second optical fiber when the second part of the attenuator body is connected to said third part; and
the body portion of the attenuating element is a polymeric thermoplastic material comprising a copolymer of methylmethacrylate (MMA) and trifluoroethylmethacrylate (TFEMA) having a molecular weight in the range of about 20,000 to 500,000; and the relative proportion of MMA to TFEMA is in the range of about 50/50 to 90/10 by weight of MMA/TFEMA.

2. A fiber optic attenuator according to claim 1, wherein the contact faces on the body portion of the attenuating element exhibit a reflectance of less than −40 dB in a transmission wavelength range of 850 nanometers (nm) to 1620 nm with respect to an associated transmission fiber whose core has a refractive index (R.I.) of about 1.44 to 1.46.

3. An attenuator according to claim 2, wherein the contact faces on the body portion of the attenuating element exhibit a reflectance of less than −55 dB at a transmission wavelength of about 1550 nm with respect to said associated transmission fiber.

4. A fiber optic attenuator according to claim 1, wherein the body portion of the attenuating element has a glass transition temperature (Tg) greater than 100 degrees C.

5. A fiber optic attenuator according to claim 1, wherein the body portion of the attenuating element transmits at least 85 percent of incident light in a transmission wavelength range of 850 nm to 1620 nm.

6. A fiber optic attenuator, comprising:
an attenuator body a first part of which is constructed and arranged to receive a first end portion of a first optical fiber, and a second part of which is constructed and arranged to receive a second end portion of a second optical fiber; and
an attenuating element including a generally disc shaped body portion having a first planar contact face on a first side of the body portion and a second planar contact face on a second, opposite side of said body portion; wherein
the attenuating element is mounted in a third part of the attenuator body so that the first contact face of the element is optically coupled to a first end face on the first end portion of the first optical fiber when the first part of the attenuator body is connected to said third part, and the second contact face of the element is optically coupled to a second end face on the second end portion of the second optical fiber when the second part of the attenuator body is connected to said third part; and
the body portion of the attenuating element is a polymeric thermoplastic material comprising polymethyl-2-fluoroacrylate (PMFA).

7. A fiber optic attenuator according to claim 6, wherein the body portion of the attenuating element exhibits a reflectance of less than −40 dB in a transmission wavelength range of 850 nm to 1620 nm with respect to an associated transmission fiber whose core has a R.I. of about 1.44 to 1.46.

8. An attenuator according to claim 7, wherein the body portion of the attenuating element exhibits a reflectance of less than −50 dB at a transmission wavelength of about 1550 nm with respect to said associated transmission fiber.

9. A fiber optic attenuator according to claim 6, wherein the body portion of the attenuating element has a Tg greater than 140 degrees C.

10. A fiber optic attenuator according to claim 6, wherein the body portion of the attenuating element transmits at least 85 percent of incident light in a transmission wavelength range of 850 nm to 1620 nm.

11. An attenuating element for use in a fiber optic attenuator, comprising:
a main body portion formed of a thermoplastics material comprising a copolymer of methylmethacrylate (MMA) and trifluoroethylmethacrylate (TFEMA) having a molecular weight in the range of about 20,000 to 500,000, and the relative proportion of MMA to TFEMA is in the range of about 50/50 to 90/10 by weight of MMA/TFEMA;
said body portion is generally disc shaped and has a first planar contact face on a first side of the body portion and a second planar contact face on a second, opposite side of said body portion; and
the first and the second contact faces are dimensioned to couple optically with end faces on corresponding first and second optical fibers when said end faces are urged into contact with the contact faces of the element.

12. An attenuating element according to claim 11, wherein the contact faces on the body portion of the attenuating element exhibit a reflectance of less than −40 dB in a transmission wavelength range of 850 nm to 1620 nm, and a reflectance of less than −55 dB at a transmission wavelength of about 1550 nm, with respect to an associated transmission fiber whose core has a R.I. of about 1.44 to 1.46.

13. An attenuating element according to claim 11, wherein the body portion of the element has a Tg of at least 100 degrees C.

14. An attenuating element according to claim 11, wherein the body portion of the element has a transmission of at least 85% in an optical wavelength range of 850 nm to 1620 nm.

15. An attenuating element for use in a fiber optic attenuator, comprising:
a main body portion formed of a thermoplastics material comprising polymethyl-2-fluoroacrylate (PMFA);
said body portion is generally disc shaped and has a first planar contact face on a first side of the body portion and a second planar contact face on a second, opposite side of said body portion; and
the first and the second contact faces are dimensioned to couple optically with end faces on corresponding first and second optical fibers when said end faces are urged into contact with the contact faces of the element.

16. An attenuating element according to claim 15, wherein the contact faces on the body portion of the attenuating element exhibit a reflectance of less than −40 dB in a transmission wavelength range of 850 nm to 1620 nm, and a reflectance of less than −50 dB at a transmission wavelength of about 1550 nm, with respect to an associated transmission fiber whose core has a R.I. of about 1.44 to 1.46.

17. An attenuating element according to claim 15, wherein the body portion of the element has a Tg of at least 140 degrees C.

18. An attenuating element according to claim 15, the body portion of the element has a transmission of at least 85% in an optical wavelength range of 850 nm to 1620 nm.
